(19) United States
(12) Patent Application Publication
(10) Pub. No.: US 2016/0109324 A1
(43) Pub. Date: Apr. 21, 2016

(54) METHOD AND APPARATUS OF MULTI-AXIS RESONANCE FATIGUE TEST

(71) Applicant: KOREA INSTITUTE OF MACHINERY & MATERIALS, Daejeon (KR)

(72) Inventors: Hakgu LEE, Changwon-si (KR); Byungsun HWANG, Jeonju-si (KR); Wookyoung LEE, Gimhae-si (KR); Mungyu JEONG, Gimhae-si (KR)

(21) Appl. No.: 14/885,731

(22) Filed: Oct. 16, 2015

Related U.S. Application Data
(60) Provisional application No. 62/065,435, filed on Oct. 17, 2014.

(51) Int. Cl. G01M 7/02; G01M 5/00

(52) U.S. Cl. CPC G01M 7/022; G01M 5/0008; G01M 5/0016

(57) ABSTRACT

A multi-axis resonance fatigue test method and apparatus are provided by considering both stiffness coupling and inertia coupling in a resonance fatigue test that causes a complicated behavior and nonsymmetrical bending of a test article such as a wind turbine blade due to a coupling effect. In the method, a processor of the apparatus calculates a load value by considering a coupling between at least two axes of the test article. Also, the processor determines respective single-axis equivalent loads from the calculated load value by considering the coupling. This coupling may include at least one of a stiffness coupling and an inertia coupling.

### CROSS REFERENCE TO RELATED APPLICATIONS

The present application claims the benefit of U.S. provisional patent application No. 62/065,435 filed Oct. 17, 2014. The present application is also related to copending patent application Ser. No. 14/885,644 titled “Method and Apparatus of Moment Calibration for Resonance Fatigue Test” and a copending patent application Ser. No. 14/885,694 titled “Method for Analyzing Measured Signal in Resonance Fatigue Test and Apparatus Using the Same” both filed on Oct. 16, 2015. The disclosures of the above-listed applications are hereby incorporated by reference herein in their entirety.

### TECHNICAL FIELD

The present invention relates to a fatigue test for a test article such as a wind turbine blade.

### BACKGROUND

A wind turbine blade is a distinguishing component of a wind power generator, and it would not be wrong to say the performance and lifetime of the entire system depend on the performance of a blade. A recent several-MW blade which is about several tens of meters long and weighs more than ten tons should be designed considering various load conditions and verified through a test. There are a static test and a fatigue test as tests for reliability verification of a blade.

Normally a fatigue test for a wind turbine blade is performed using a fatigue test apparatus 100 as shown in FIG. 1. Referring to FIG. 1, a blade 110 is fixed at a root to a test stand 120, thus forming a cantilever beam. An exciter 130 is mounted on the blade 110 and applies a repeated force to the blade 110 so as to induce oscillation of a cantilever beam.

An excitation force is adjusted so that a bending moment distribution caused by oscillation of the blade 110 can exceed a target bending moment distribution. Using resonance, the blade 110 vibrates at a certain amplitude in a target cycle. Typically such a target cycle is set to several million cycles. For example, a full-scale fatigue test needs a flapwise test with 1 million cycles and an edgewise test with 2 million cycles, spending a very long test time of about three months.

Fatigue testing methods are classified into two categories, i.e., forced-displacement type fatigue testing and resonance type fatigue testing. Between both, the latter type has recently attracted attention in view of providing a greater oscillating range required. Namely, a resonance fatigue test can be efficiently conducted at the natural frequency exploiting resonance. Since allowing the blade to oscillate at a great amplitude even by a smaller actuating force, a resonance fatigue test can considerably reduce energy required for a fatigue test.

Additionally, a fatigue test includes a flapwise test for actuating the blade in a flapwise direction and an edgewise test for actuating the blade in an edgewise direction. A single-axis test is to perform separately both tests, and a dual-axis test is to perform simultaneously both tests.

Further, dual-axis resonance fatigue tests are divided into one case having same frequencies and constant amplitude in flapwise and edgewise directions, and the other case having different frequencies and variable amplitude in flapwise and edgewise directions.

FIG. 2A is a diagram illustrating the displacement of blade tip in the former case, and FIG. 2B is a graph illustrating the blade displacement in an edgewise direction in the former case. In FIG. 2A, the horizontal axis represents the blade tip displacement (unit: inch) in an edgewise direction (also referred to as lead-lag tip displacement), and the vertical axis represents the blade tip displacement (unit: inch) in a flapwise direction (also referred to as flap tip displacement). In FIG. 2B, the horizontal axis represents time (unit: second), and the vertical axis represents edgewise blade displacement (unit: meter). Additionally, FIG. 3A is a diagram illustrating the displacement of blade tip in the latter case, and FIG. 3B is a graph illustrating the blade displacement in an edgewise direction in the latter case. Further, FIG. 3C is a diagram illustrating the contour of blade motions superposed at some positions on blade in the latter case. In FIG. 3B, the horizontal axis represents time (unit: second), and the vertical axis represents edgewise blade displacement (unit: meter). In FIG. 3C, 55.6 m, 48.0 m, etc. respectively represent distances from a blade root.

In the former case, flapwise and edgewise blade motions give rise to no interference therebetween. Further, such motions are made with a single frequency. It is therefore possible and not difficult to predict the behavior of blade and also perform a test setup through a harmonic analysis.

By the way, the latter case is more realistic than the former case. In the latter case, flapwise and edgewise blade motions with different frequencies give rise to interference therebetween. Therefore, a harmonic analysis is not possible. Even in a transient analysis, due to two frequencies with no multiple relations as shown in FIG. 3B, finding convergence is very difficult and requires a great burden of calculation. As a result, the latter case makes it difficult to predict the behavior of blade and also perform a test setup.

A real resonance fatigue test is in a dynamic load state and thereby causes nonsymmetrical bending of the blade due to stiffness coupling even in a single-axis test as well as in a dual-axis test. Therefore, as shown in FIGS. 3A and 3C, the blade moves in a diagonal direction which is not parallel with the direction of excitation force applied to the blade. This diagonal motion of the blade brings about an inertia force having horizontal and vertical components, resulting in dual-axis load components. Namely, interference between flapwise and edgewise motions of the blade inherently causes an inertia coupling (or referred to as a mass coupling).

As discussed hereinbefore, a dual-axis resonance fatigue test having different frequencies and variable amplitude in flapwise and edgewise directions makes it difficult to exactly predict the behavior of blade and efficiently perform a test setup due to the difficulty of predicting a coupling effect.

### SUMMARY

Accordingly, in order to address the aforesaid or any other issue, the present invention provides a multi-axis resonance fatigue test method and apparatus by considering both stiffness coupling and inertia coupling in a resonance fatigue test that causes a complicated behavior and nonsymmetrical bending of a test article due to a coupling effect.

Various embodiments of the present invention provide a multi-axis resonance fatigue test method for a test article. This method may include steps of: calculating a load value by considering a coupling between at least two axes of the test article; and determining respective single-axis equivalent loads from the calculated load value by considering the coupling.

The method may further include step of comparing the determined single-axis equivalent load with a target load so as to verify whether the single-axis equivalent load exceeds the target load within a verification region.

The method may further include step of exciting the test article by using the determined single-axis equivalent load in directions of the at least two axes with different frequencies and variable amplitude.

In the method, coupling may include at least one of a stiffness coupling and an inertia coupling between the at least two axes of the test article.

In the method, at least one of the calculating step and the determining step may be performed based on calibration results obtained in view of a multi-axis load state of the test article.

In the method, the calculating step may include receiving a measured signal from each of at least two measurement sensors attached to the test article; and calculating the load value from the received measured signal by considering all of a first measured value in a first direction due to a first direction load, a second measured value in a second direction due to the first direction load, a third measured value in the first direction due to a second direction load, and a fourth measured value in the second direction due to the second direction load.

Meanwhile, various embodiments of the present invention provide a multi-axis resonance fatigue test apparatus for a test article. This apparatus may include a test stand configured to fix one end of the test article; an exciter mounted on the test article and configured to apply a repeated force to the test article so as to induce oscillation; a controller connected to the exciter and configured to apply a driving force to the exciter; and a processor configured to calculate a load value by considering a coupling between at least two axes of the test article, and to determine respective single-axis equivalent loads from the calculated load value by considering the coupling.

In the apparatus, the processor may be further configured to compare the determined single-axis equivalent load with a target load so as to verify whether the single-axis equivalent load exceeds the target load within a verification region.

In the apparatus, the controller may be further configured to excite the test article by using the determined single-axis equivalent load in directions of the at least two axes with different frequencies and variable amplitude.

In the apparatus, the coupling may include at least one of a stiffness coupling and an inertia coupling between the at least two axes of the test article.

In the apparatus, the processor may be further configured to use calibration results obtained in view of a multi-axis load state of the test article when calculating the load value or determining the single-axis equivalent loads.

In the apparatus, the processor may be further configured to receive a measured signal from each of at least two measurement sensors attached to the test article, and to calculate the load value from the received measured signal by considering all of a first measured value in a first direction due to a first direction load, a second measured value in a second direction due to the first direction load, a third measured value in the first direction due to a second direction load, and a fourth measured value in the second direction due to the second direction load.

In the above method and apparatus, the test article may be one of a wind turbine blade, a bridge, a building, a yacht mast, or any other structure which has a possibility of oscillation and needs a fatigue test.

### BRIEF DESCRIPTION OF THE DRAWINGS

FIG. 1 is a schematic diagram illustrating a typical resonance fatigue test apparatus.

FIG. 2A is a diagram illustrating the displacement of blade tip in case of a dual-axis resonance fatigue test having same frequencies and constant amplitude in flapwise and edgewise directions.

FIG. 2B is a graph illustrating the blade displacement in an edgewise direction in case of a dual-axis resonance fatigue test having same frequencies and constant amplitude in flapwise and edgewise directions.

FIG. 3A is a diagram illustrating the displacement of blade tip in case of a dual-axis resonance fatigue test having different frequencies and variable amplitude in flapwise and edgewise directions.

FIG. 3B is a graph illustrating the blade displacement in an edgewise direction in case of a dual-axis resonance fatigue test having different frequencies and variable amplitude in flapwise and edgewise directions.

FIG. 3C is a diagram illustrating the contour of blade motions superposed at some positions on blade in case of a dual-axis resonance fatigue test having different frequencies and variable amplitude in flapwise and edgewise directions.

FIG. 4 is a schematic diagram illustrating a dual-axis resonance fatigue test apparatus according to an embodiment of the present invention.

FIG. 5 is a flow diagram illustrating a dual-axis resonance fatigue test method according to an embodiment of the present invention.

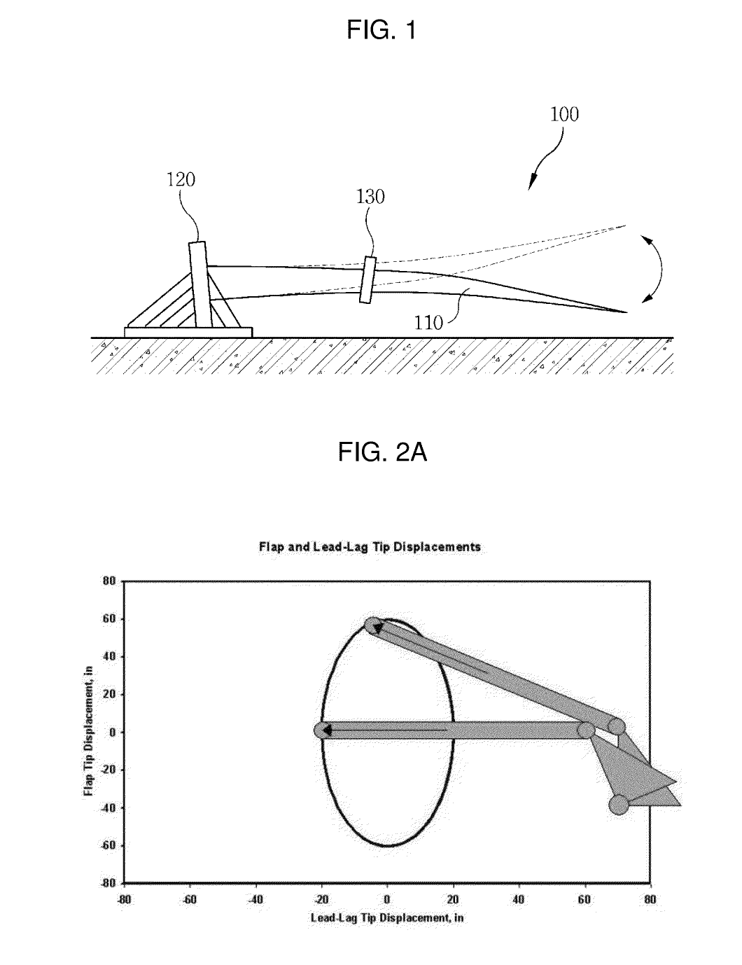

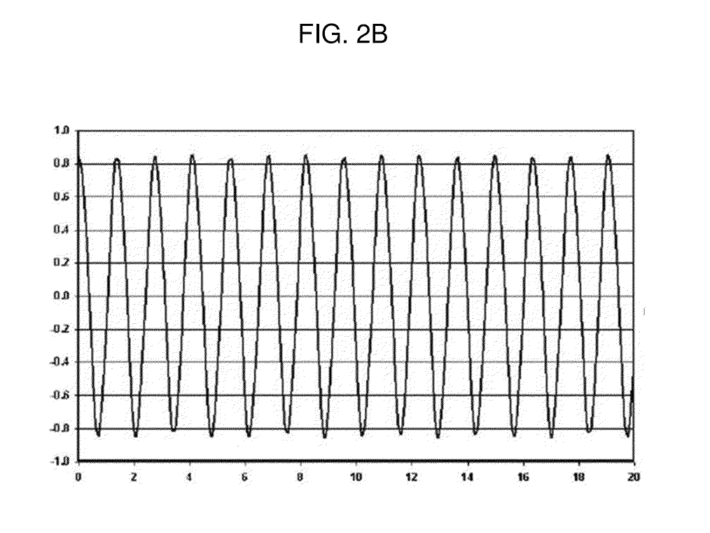

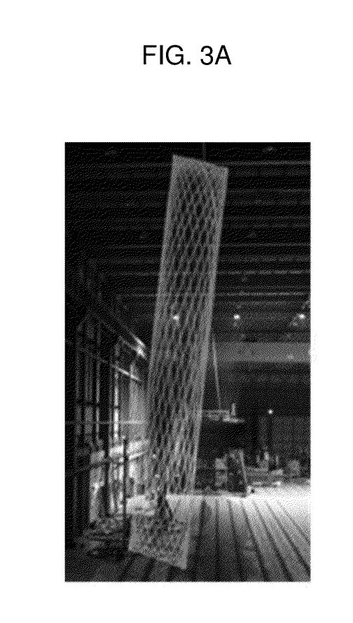

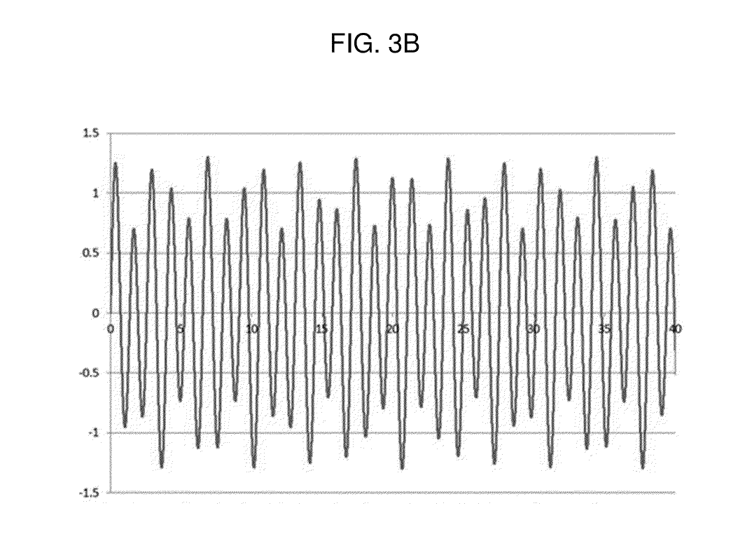

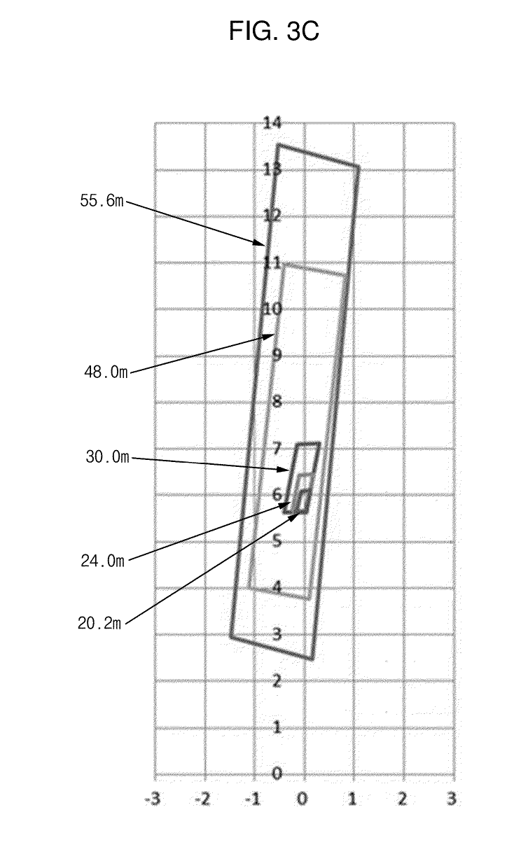

### DETAILED DESCRIPTION

Hereinafter, embodiments of the present invention will be described with reference to the accompanying drawings.

This invention may be embodied in many different forms and should not be construed as limited to the embodiments set forth herein. Rather, the disclosed embodiments are provided so that this invention will be thorough and complete, and will fully convey the scope of the invention to those skilled in the art. The principles and features of the present invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention. Through the drawings, the same or similar reference numerals denote corresponding features consistently.

Unless defined differently, all terms used herein, which include technical terminologies or scientific terminologies, have the same meaning as that understood by a person skilled in the art to which the present invention belongs. Singular forms are intended to include plural forms unless the context clearly indicates otherwise.

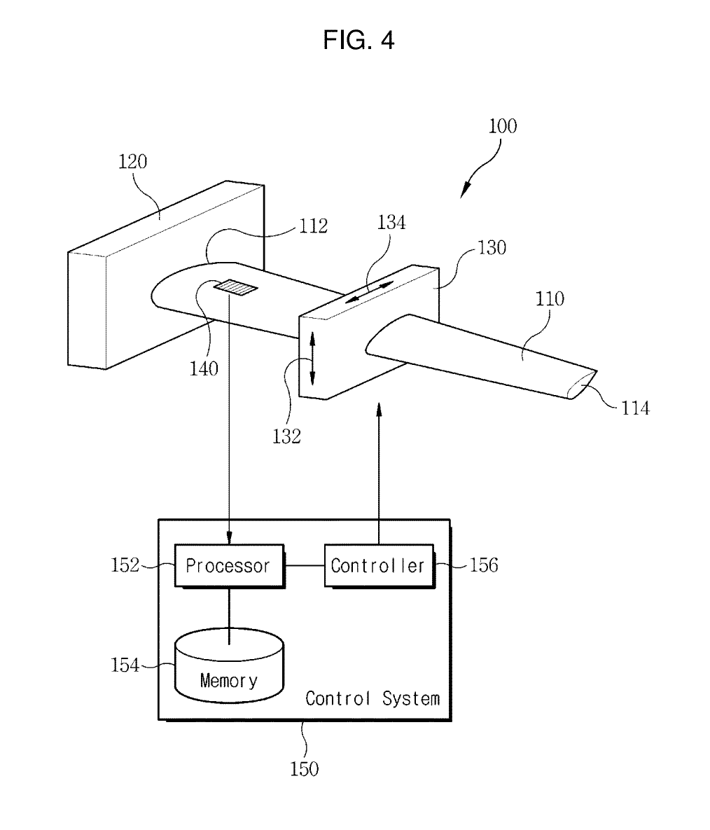

FIG. 4 is a schematic diagram illustrating a dual-axis resonance fatigue test apparatus according to an embodiment of the present invention.

Referring to FIG. 4, the dual-axis resonance fatigue test apparatus 100 is an apparatus configured to perform a fatigue test for a test article such as a wind turbine blade 110. Although the test article is a wind turbine blade in this embodiment, this is exemplary only and not to be considered as a limitation of the present invention. In other various embodiments, the test article may be a bridge, a building, a yacht mast, or any other structure which has a possibility of oscillation and needs a fatigue test.

Additionally, the resonance fatigue test apparatus 100 shown in FIG. 4 is a dual-axis test apparatus that simultaneously performs a flapwise test for actuating the blade 110 in a flapwise direction 132 and an edgewise test for actuating the blade 110 in an edgewise direction 134. This is, however, exemplary only and not to be considered as a limitation of this invention. The present invention may also be applied to any other multi-axis resonance fatigue test for the blade 110.

The blade 110 is fixed to a test stand 120 at one end thereof, i.e., a root 112, thus forming a cantilever beam. The other end of the blade 110 is referred to as a tip 114.

An exciter 130 is mounted on the blade 110. The exciter 130 applies a repeated force to the blade 110 under the control of a controller 156 to be discussed below, thus inducing oscillation of the blade 110. The exciter 130 is illustrated simply in FIG. 4, and types or detailed structures thereof do not limit the invention. Namely, the exciter 130 may have various types such as external exciter type, on-board rotating exciter type, on-board linear exciter type, and the like, and each type exciter may have various structures. For example, in case of on-board linear exciter type, the exciter 130 has an actuator and a mass. The actuator enables the mass to move back and forth linearly, thereby creating an inertia force. A resonance fatigue test adjusts the oscillating frequency of such a linear motion of the mass to approach the natural frequency of the entire blade structure so that resonance occurs. In case of a dual-axis resonance fatigue test, the exciter 130 may be separately formed of a flapwise exciter and an edgewise exciter, or alternatively implemented in the form of an integrated structure in which a flapwise actuator and an edgewise actuator are equipped together.

A dual-axis resonance fatigue test is controlled by a control system 150, which includes a processor 152, a memory 154, and a controller 156. The memory 154 stores test conditions and data required for or associated with a resonance fatigue test. For example, one of test conditions prescribes that a test bending moment distribution caused by oscillation of the blade 110 should exceed a target bending moment distribution. Data stored in the memory 154 may include a target cycle of fatigue test, a natural frequency of blade, a target moment load, a test moment load calculated by the processor 152, a single-axis equivalent load induced from the calculated load by the processor 152, and the like. Each kind of data may have different values according to flapwise and edgewise directions.

The controller 156 is connected to the exciter 130 and applies an excitation force to the exciter 130. Namely, based on test conditions and data stored in the memory 154, the controller 156 adjusts the excitation force of the exciter 130 to oscillate the blade 110 with a desired amplitude in a target cycle. In case of a dual-axis test, the controller 156 may separately apply a flapwise control signal and an edgewise control signal to the exciter 130. At this time, a flapwise frequency and an edgewise frequency may be different from each other.

At least two strain gauges 140 are attached respectively to several spots of the blade 110. The strain gauge 140 creates a measured signal by measuring a physical quantity (e.g., strain) caused by oscillation of the blade 110 and then transmits the measured signal to the processor 152. The processor 152 processes the measured signal and stores the processed signal in the memory unit 154. Also, based on the processed signal, the controller 156 performs a control operation. The strain gauge 140 is an example of a measurement sensor and not to be considered as a limitation of this invention. Alternatively or additionally, any other sensor such as an optical sensor, an acceleration sensor, a displacement gauge, or the like may be selectively used. If there are a lot of strain gauges 140, a data acquisition device (not shown) may be used for collecting the measured signals from the strain gauges 140 and for transmitting the collected signals to the processor 152.

In FIG. 4, a single strain gauge 140 is shown to avoid complexity. However, practically, at least two strain gauges 140 should be disposed at different positions on the same cross-section of the blade 110 (i.e., at the same distance from the blade root). Additionally, such dispositions of the strain gauges 140 may be distributed at several cross-sections along the longitudinal direction of the blade 110.

Meanwhile, the strain gauge 140 may be used for moment calibration performed before a fatigue test. In the moment calibration, a static load is applied to the blade 110, and a resultant measured value (e.g., strain) is obtained from the strain gauges 140. After this process is performed separately in the flapwise direction and in the edgewise direction, a correlation (e.g., linear ratio) between the measured values and moment values obtained from the static loads is calculated. If a measured signal is received from the strain gauge 140 during a fatigue test, the processor 152 can calculate a load value (e.g., a test moment load) by using this correlation which is predetermined by means of moment calibration. This moment calibration is fully disclosed in a copending patent application Ser. No. 14/885,644 titled “Method and Apparatus of Moment Calibration for Resonance Fatigue Test”, which is hereby incorporated by reference in its entirety into the present application.

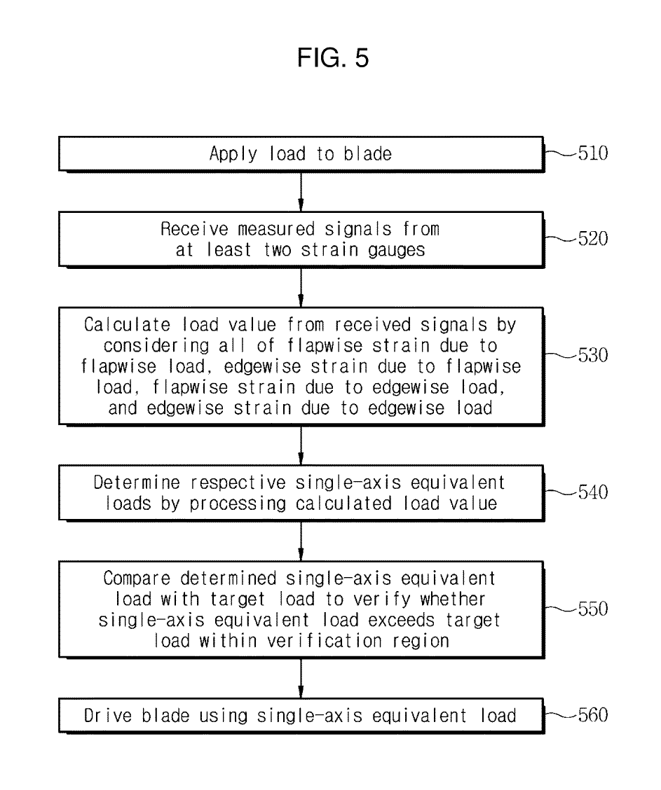

Now, a multi-axis resonance fatigue test method according to an embodiment of the present invention will be described with reference to FIG. 5. FIG. 5 is a flow diagram illustrating a dual-axis resonance fatigue test method according to an embodiment of the present invention. This method may be performed at the processor 152 of the control system 150 as shown in FIG. 4.

Referring to FIG. 5, at step 510, the controller 156 of the control system 150 applies a driving force to the exciter 130, based on test conditions and data stored in the memory 154. By the excitation of the exciter 130, a load is applied to the blade 110 and thereby oscillation of the blade 110 occurs.

Next, at step 520, the processor 152 receives a measured signal from each of at least two strain gauges 140. This measured signal is a response signal created according to the behavior of the blade 110. By the way, since the behavior of the blade 110 is very complicated due to interference (i.e., coupling) between flapwise and edgewise motions, a process of extracting a desired physical quantity form the measured signal is needed.

Therefore, at step 530, the processor 152 calculates a load value (e.g., a test moment load) from the received, measured signal by considering all of a flapwise strain due to a flapwise load, an edgewise strain due to a flapwise load, a flapwise strain due to an edgewise load, and an edgewise strain due to an edgewise load.

Steps 510, 520 and 530 are fully disclosed in a copending patent application Ser. No. 14/885,694 titled “Method for Analyzing Measured Signal in Resonance Fatigue Test and Apparatus Using the Same”, which is hereby incorporated by reference in its entirety into the present application.

Particularly, the calculation of a load value at step 530 is performed considering a dual-axis coupling of the blade 110. For example, both stiffness coupling and inertia coupling caused by flapwise and edgewise motions of the blade 110 are considered. Equation 1 given below expresses stiffness coupling and inertia coupling in a dual-axis resonance fatigue test.

$$\{ \begin{matrix}\frac{1}{{ρ}_{x}} \\ \frac{1}{{ρ}_{y}}\end{matrix} \} = [ \begin{matrix}\frac{{EI}_{yy}}{{EI}_{xx} {EI}_{yy} - {( {EI}_{xy} )}^{2}} & \frac{- {EI}_{xy}}{{EI}_{xx} {EI}_{yy} - {( {EI}_{xy} )}^{2}} \\ \frac{- {EI}_{xy}}{{EI}_{xx} {EI}_{yy} - {( {EI}_{xy} )}^{2}} & \frac{{EI}_{xx}}{{EI}_{xx} {EI}_{yy} - {( {EI}_{xy} )}^{2}}\end{matrix} ] \{ \begin{matrix}{M}_{x} \\ {M}_{y}\end{matrix} \} \qquad [ Equation 1 ]$$

In Equation 1, a 2×2 matrix regarding bending stiffness (EI) represents stiffness coupling, and a 2×1 matrix regarding moment load (M) represents dual-axis moment components. Stiffness coupling is caused by material characteristics and shape characteristics of the blade. Dual-axis moment components are caused by an inertia force during a resonance motion of the blade. In case of a dual-axis fatigue test, flapwise and edgewise motions of the blade invoke interference therebetween, so that moment is also subjected to coupling. Namely, moment coupling may be regarded as occurring by inertia coupling (or referred to as mass coupling) due to a blade behavior.

Next, at step 540, the processor 152 determines a single-axis equivalent load by processing the measured load value.

Specifically, Equation 2 given below expresses curvatures in a single-axis load. In Equation 2, ρₓ and ρ_{y} denote a curvature with regard to edgewise bending and a curvature with regard to flapwise bending, respectively. In addition, Mₓ and M_{y} denote an edgewise moment load and a flapwise moment load, respectively. Also, EIₓₓ and EI_{yy} denote edgewise bending stiffness and flapwise bending stiffness, respectively. And also, EI_{xy} denotes bending stiffness associated with stiffness coupling.

$$\frac{1}{{ρ}_{x}} = \frac{{EI}_{yy}}{{EI}_{xx} {EI}_{yy} - {( {EI}_{xy} )}^{2}} {M}_{x} \\ \frac{1}{{ρ}_{y}} = \frac{{EI}_{xx}}{{EI}_{xx} {EI}_{yy} - {( {EI}_{xy} )}^{2}} {M}_{y} \qquad [ Equation 2 ]$$

Additionally, Equation 3 expresses curvatures in a dual-axis load.

$$\frac{1}{{ρ}_{x}} = \frac{{EI}_{yy}}{{EI}_{xx} {EI}_{yy} - {( {EI}_{xy} )}^{2}} [ {M}_{x} - \frac{{EI}_{xy}}{{EI}_{yy}} {M}_{y} ] \\ \frac{1}{{ρ}_{y}} = \frac{{EI}_{xx}}{{EI}_{xx} {EI}_{yy} - {( {EI}_{xy} )}^{2}} [ - \frac{{EI}_{xy}}{{EI}_{xx}} {M}_{x} + {M}_{y} ] \qquad [ Equation 3 ]$$

From Equations 2 and 3, equivalent moments can be obtained as Equation 4.

$$\{ \begin{matrix}{M}_{x}^{( eq )} \\ {M}_{y}^{( eq )}\end{matrix} \} = [ \begin{matrix}1 & - \frac{{EI}_{xy}}{{EI}_{yy}} \\ - \frac{{EI}_{xy}}{{EI}_{xx}} & 1\end{matrix} ] \{ \begin{matrix}{M}_{x} \\ {M}_{y}\end{matrix} \} \qquad [ Equation 4 ]$$

Meanwhile, Equation 5 expresses dual-axis strains. In Equation 5, ε_{zz} denotes a strain. Also, e_{f}⁽ⁱ⁾ denotes a linear ratio between a flapwise moment and a measured strain value, and eₑ⁽ⁱ⁾ denotes a linear ratio between an edgewise moment and a measured strain value.

$$\{ \begin{matrix}{ɛ}_{zz}^{( 1 )} \\ {ɛ}_{zz}^{( 2 )}\end{matrix} \} = [ \begin{matrix}{e}_{e}^{( 1 )} & {e}_{f}^{( 1 )} \\ {e}_{e}^{( 2 )} & {e}_{f}^{( 2 )}\end{matrix} ] \{ \begin{matrix}{M}_{x} \\ {M}_{y}\end{matrix} \} \\ \begin{matrix}\{ \begin{matrix}{M}_{x} \\ {M}_{y}\end{matrix} \} = {[ \begin{matrix}{e}_{e}^{( 1 )} & {e}_{f}^{( 1 )} \\ {e}_{e}^{( 2 )} & {e}_{f}^{( 2 )}\end{matrix} ]}^{- 1} \{ \begin{matrix}{ɛ}_{zz}^{( 1 )} \\ {ɛ}_{zz}^{( 2 )}\end{matrix} \} \\ = {\frac{1}{{e}_{e}^{( 1 )} {e}_{f}^{( 2 )} - {e}_{e}^{( 2 )} {e}_{f}^{( 1 )}} [ \begin{matrix}{e}_{f}^{( 2 )} & - {e}_{f}^{( 1 )} \\ - {e}_{e}^{( 2 )} & {e}_{e}^{( 1 )}\end{matrix} ]}^{- 1} \{ \begin{matrix}{ɛ}_{zz}^{( 1 )} \\ {ɛ}_{zz}^{( 2 )}\end{matrix} \}\end{matrix} \qquad [ Equation 5 ]$$

From Equations 4 and 5, dual-axis equivalent moments can be obtained as Equation 6.

$$\{ \begin{matrix}{M}_{x}^{( eq )} \\ {M}_{y}^{( eq )}\end{matrix} \} = \frac{1}{{e}_{e}^{( 1 )} {e}_{f}^{( 2 )} - {e}_{e}^{( 2 )} {e}_{f}^{( 1 )}} [ \begin{matrix}{e}_{f}^{( 2 )} + {e}_{e}^{( 2 )} \frac{{EI}_{xy}}{{EI}_{yy}} & - {e}_{f}^{( 1 )} - {e}_{e}^{( 1 )} \frac{{EI}_{xy}}{{EI}_{yy}} \\ - {e}_{e}^{( 2 )} - {e}_{f}^{( 2 )} \frac{{EI}_{xy}}{{EI}_{xx}} & {e}_{e}^{( 1 )} + {e}_{f}^{( 1 )} \frac{{EI}_{xy}}{{EI}_{xx}}\end{matrix} ] \{ \begin{matrix}{ɛ}_{zz}^{( 1 )} \\ {ɛ}_{zz}^{( 2 )}\end{matrix} \} \qquad [ Equation 6 ]$$

Therefore, a flapwise equivalent moment can be expressed as Equation 7, and an edgewise equivalent moment can be expressed as Equation 8. In Equation 7, PS indicates a pressure side of the blade in the flapwise direction, and SS indicates a suction side of the blade in the flapwise direction. Also, in Equation 8, LE indicates a leading edge of the blade in the edgewise direction, and TE indicates a trailing edge of the blade in the edgewise direction.

$$\begin{matrix}{M}_{y}^{( eq )} = \frac{- ( {e}_{e}^{( SS )} + {e}_{f}^{( SS )} \frac{{EI}_{xy}}{{EI}_{xx}} ) {ɛ}_{zz}^{( PS )} + ( {e}_{e}^{( PS )} + {e}_{f}^{( PS )} \frac{{EI}_{xy}}{{EI}_{xx}} ) {ɛ}_{zz}^{( SS )}}{{e}_{e}^{( PS )} {e}_{f}^{( SS )} - {e}_{e}^{( SS )} {e}_{f}^{( PS )}} & [ Equation 7 ] \\ {M}_{x}^{( eq )} = \frac{( {e}_{f}^{( TE )} + {e}_{e}^{( TE )} \frac{{EI}_{xy}}{{EI}_{yy}} ) {ɛ}_{zz}^{( LE )} - ( {e}_{f}^{( LE )} + {e}_{e}^{( LE )} \frac{{EI}_{xy}}{{EI}_{yy}} ) {ɛ}_{zz}^{( TE )}}{{e}_{e}^{( LE )} {e}_{f}^{( TE )} - {e}_{e}^{( TE )} {e}_{f}^{( LE )}} & [ Equation 8 ]\end{matrix}$$

As described above, from the calculated load value, respective single-axis equivalent loads can be determined.

Next, at step 550, the processor 152 compares the determined single-axis equivalent load with a target load so as to verify whether the single-axis equivalent load exceeds the target load within a verification region.

According to test conditions, a test moment load should exceed a target moment load. Therefore, based on verification results of step 550, the processor 152 may adjust a driving force to be applied to the exciter 130 through the controller 156. Then, at step 560, the controller 156 controls the exciter 130 by using such a single-axis equivalent load so that the exciter 130 excites the blade 110 in the flapwise and edgewise directions with different frequencies and variable amplitude.

The above-discussed multi-axis resonance fatigue test method according to the present invention can be efficiently applied to a test setup procedure for a resonance fatigue test as well as to the full-scale resonance fatigue test.

While the present invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A multi-axis resonance fatigue test method for a test article, the method comprising steps of:
calculating a load value by considering a coupling between at least two axes of the test article; and
determining respective single-axis equivalent loads from the calculated load value by considering the coupling.

2. The method of claim 1, further comprising step of:
comparing the determined single-axis equivalent load with a target load so as to verify whether the single-axis equivalent load exceeds the target load within a verification region.

3. The method of claim 1, further comprising step of:
exciting the test article by using the determined single-axis equivalent load in directions of the at least two axes with different frequencies and variable amplitude.

4. The method of claim 1, wherein the coupling includes at least one of a stiffness coupling and an inertia coupling between the at least two axes of the test article.

5. The method of claim 1, wherein at least one of the calculating step and the determining step is performed based on calibration results obtained in view of a multi-axis load state of the test article.

6. The method of claim 1, wherein the calculating step includes:
receiving a measured signal from each of at least two measurement sensors attached to the test article; and
calculating the load value from the received measured signal by considering all of a first measured value in a first direction due to a first direction load, a second measured value in a second direction due to the first direction load, a third measured value in the first direction due to a second direction load, and a fourth measured value in the second direction due to the second direction load.

7. The method of claim 1, wherein the test article is one of a wind turbine blade, a bridge, a building, a yacht mast, or any other structure which has a possibility of oscillation and needs a fatigue test.

8. A multi-axis resonance fatigue test apparatus for a test article, the apparatus comprising:
a test stand configured to fix one end of the test article;
an exciter mounted on the test article and configured to apply a repeated force to the test article so as to induce oscillation;
a controller connected to the exciter and configured to apply a driving force to the exciter; and
a processor configured to calculate a load value by considering a coupling between at least two axes of the test article, and to determine respective single-axis equivalent loads from the calculated load value by considering the coupling.

9. The apparatus of claim 8, wherein the processor is further configured to compare the determined single-axis equivalent load with a target load so as to verify whether the single-axis equivalent load exceeds the target load within a verification region.

10. The apparatus of claim 8, wherein the controller is further configured to excite the test article by using the determined single-axis equivalent load in directions of the at least two axes with different frequencies and variable amplitude.

11. The apparatus of claim 8, wherein the coupling includes at least one of a stiffness coupling and an inertia coupling between the at least two axes of the test article.

12. The apparatus of claim 8, wherein the processor is further configured to use calibration results obtained in view of a multi-axis load state of the test article when calculating the load value or determining the single-axis equivalent loads.

13. The apparatus of claim 8, wherein the processor is further configured to receive a measured signal from each of at least two measurement sensors attached to the test article, and to calculate the load value from the received measured signal by considering all of a first measured value in a first direction due to a first direction load, a second measured value in a second direction due to the first direction load, a third measured value in the first direction due to a second direction load, and a fourth measured value in the second direction due to the second direction load.

14. The apparatus of claim 8, wherein the test article is one of a wind turbine blade, a bridge, a building, a yacht mast, or any other structure which has a possibility of oscillation and needs a fatigue test.
